(19) United States
(12) Patent Application Publication
(10) Pub. No.: US 2026/0129408 A1
(43) Pub. Date: May 7, 2026

(54) MUTUAL AUTHENTICATION FOR VEHICULAR COMMUNICATIONS USING A PROXY DEVICE

(71) Applicant: TOYOTA MOTOR ENGINEERING & MANUFACTURING NORTH AMERICA, INC., PLANO, TX (US)

(72) Inventors: MICHAEL A. CLIFFORD, Mountain View, CA (US); ROHIT GUPTA, Santa Clara, CA (US); HIDEKI HADA, Ann Arbor, MI (US); JOHN B. KENNEY, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/936,939

(22) Filed: Nov. 4, 2024

(51) Int. Cl. H04W 4/38; H04W 12/043; H04W 12/06; H04W 64/00

(52) U.S. Cl. CPC H04W 4/38; H04W 12/043; H04W 12/06; H04W 64/00

(57) ABSTRACT

Systems and methods are provided for authenticating vehicle communications. The system can identify, by a roadway device, a vehicle traveling on a roadway and authenticate a proxy device associated with the vehicle. Sensor data can be transmitted to the vehicle based on the authentication of the proxy device, wherein the vehicle is operated to navigate the roadway based on the sensor data.

### TECHNICAL FIELD

The present disclosure relates generally to systems and methods for authenticating vehicle communications, and, more particularly, some embodiments relate to authenticating vehicle communications using proxy devices carried by a vehicle involved in the communications.

### DESCRIPTION OF RELATED ART

Vehicles are equipped with various sensors, including cameras, radar, Light Detection and Ranging (LIDAR) and ultrasound. These sensors are used to detect environment about a vehicle, including other vehicles, obstacles, and roadway users (e.g., pedestrians, cyclists, etc.), among others. The detections can be used to inform vehicle operation and make operational decisions for the vehicle. For example, detections can be presented to a driver of the vehicle to inform the driver on the environmental conditions. As another example, autonomous vehicles can utilize detections to operate the vehicle autonomously. Furthermore, information can be obtained from roadway devices, such as other vehicles, roadside infrastructure, and the like, to inform the vehicle on environmental conditions, such as occluded obstacles or road conditions that the vehicle is unable to detect.

### BRIEF SUMMARY OF THE DISCLOSURE

According to various embodiments of the disclosed technology, a method can comprise identifying, by a roadway device, a vehicle traveling on a roadway; authenticating, by the roadway device, a proxy device associated with the vehicle; and transmitting sensor data to the vehicle based on the authentication of the proxy device, wherein the vehicle is operated to navigate the roadway based on the sensor data.

In some embodiments, the method further comprises obtaining a geographic location of the proxy device; obtaining a geographic location of the vehicle; and authenticating the vehicle based on the geographic location of the proxy device matching the geographic location of the vehicle.

In some embodiments authenticating the vehicle based on the geographic location of the proxy device matching the geographic location of the vehicle comprises: determining a geographic area of the vehicle based on the geographic location of the vehicle; and determining that the geographic location of the proxy device is within the geographic area.

In some embodiments, the method further comprises rejecting communications between the vehicle and the roadway device in a case where the geographic location of the proxy device is outside the geographic area.

In some embodiments, the proxy device is contained in a cabin of the vehicle.

In some embodiments, authenticating the proxy device uses a public key infrastructure.

In some embodiments, the proxy device is one of a: mobile phone, wearable smart device, a tablet computer, or laptop computer.

In some embodiments, identifying the vehicle traveling on the roadway comprises: identifying one or more vehicles affected by a condition based on the sensor data, wherein the one or more vehicles are identified from a plurality of vehicles traveling on the roadway; and transmitting the sensor data to the only the identified vehicles based on authenticating one or more proxy devices associated with the identified vehicles, wherein the sensor data is not transmitted to the remaining vehicles of the plurality of vehicles.

According to various embodiments of the disclosed technology, a vehicle can comprise a communication circuit configured to exchange communications with a roadway device; a memory storing instructions; and one or more processors communicably coupled to the memory and configured to execute the instructions to: identify that the vehicle is traveling on a roadway; receive, by the roadway device, authentication for a proxy device associated with the vehicle that is located in the vehicle's cabin; and receive sensor data based on the authentication of the proxy device, wherein the vehicle is operated to navigate the roadway based on the sensor data.

In some embodiments, the one or more processors are further configured to: obtain a geographic location of the proxy device; obtain a geographic location of the vehicle; and receive the authentication for the vehicle based on the geographic location of the proxy device matching the geographic location of the vehicle.

In some embodiments, the one or more processors are further configured to determine a geographic area of the vehicle based on the geographic location of the vehicle; and determine that the geographic location of the proxy device is within the geographic area.

In some embodiments, the one or more processors are further configured to reject communications between the vehicle and the roadway device in a case where the geographic location of the proxy device is outside the geographic area.

In some embodiments, authenticating the proxy device uses a public key infrastructure.

In some embodiments, the proxy device is one of a: mobile phone, wearable smart device, a tablet computer, or laptop computer.

In some embodiments, the one or more processors are further configured to identify one or more vehicles affected by a condition based on the sensor data, wherein the one or more vehicles are identified from a plurality of vehicles traveling on the roadway; and transmit the sensor data to only the identified vehicles based on authentication of one or more proxy devices associated with the identified vehicles, wherein the sensor data is not transmitted to the remaining vehicles of the plurality of vehicles.

According to various embodiments of the disclosed technology, a non-transitory machine-readable storage medium can be encoded with instructions, which, when executed by a processor, can cause the processor to identify, by a roadway device, a vehicle traveling on a roadway; authenticate, by the roadway device, a proxy device associated with the vehicle; and transmit sensor data to the vehicle based on the authentication of the proxy device, wherein the vehicle is operated to navigate the roadway based on the sensor data.

In some embodiments, the processor is further configured to obtain a geographic location of the proxy device; obtain a geographic location of the vehicle; and authenticate the vehicle based on the geographic location of the proxy device matching the geographic location of the vehicle using a public key infrastructure.

In some embodiments, the processor is further configured to determine a geographic area of the vehicle based on the geographic location of the vehicle; and determine that the geographic location of the proxy device is within the geographic area.

In some embodiments, the processor is further configured to reject communications between the vehicle and the roadway device in a case where the geographic location of the proxy device is outside the geographic area.

In some embodiments, the processor is further configured to identify one or more vehicles affected by a condition based on the sensor data, wherein the one or more vehicles are identified from a plurality of vehicles traveling on the roadway; and transmit the sensor data to the only the identified vehicles based on authenticating one or more proxy devices associated with the identified vehicles, wherein the sensor data is not transmitted to the remaining vehicles of the plurality of vehicles.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example vehicular communication authentication system for authenticating one or more vehicles in accordance with various embodiments disclosed herein.

FIG. 2 is a schematic representation of an example hybrid vehicle with which embodiments of the systems and methods disclosed herein may be implemented.

FIG. 3 illustrates an example architecture for authenticating vehicle communications in accordance with one embodiment of the systems and methods described herein.

FIG. 4 is a flow chart illustrating example operations for authenticating vehicular communications in accordance with various embodiments disclosed herein.

FIG. 5 is an example computing component that may be used to implement various features of embodiments described in the present disclosure.

The figures are not exhaustive and do not limit the present disclosure to the precise form disclosed.

### DETAILED DESCRIPTION

The presently disclosed technology provides for directing communications at specific vehicles by authenticating a proxy associated with a vehicle. The proxy, in various examples, can be implemented to authenticate the vehicle, such that authentication of the proxy functions as authentication for the vehicle associated therewith. The proxy may be provided as a non-vehicle device (also referred to herein as a “proxy device”) that is associated with a vehicle. Said another way, the proxy device may be a device that is distinct from the vehicle, but may be otherwise carried within a cabin or other portion of the vehicle. For example, the proxy device may be provided as a mobile device of a driver or other occupant of the vehicle, a wearable smart device (e.g., a smart watch, smart ring, or the like) of a driver or other occupant, or any device that can be carried into or out of the vehicle that is capable of wireless communications.

As alluded to above, vehicles can use information obtained from other vehicles to inform operation of the vehicle. For example, a roadway device may be located at an intersection and may be implemented to communicate information to vehicles to inform said vehicles of need to reduce speed. In this example, the roadway device may utilize sensors or receive information characterizing conditions at the intersection that may be difficult for an operator of the vehicle to see (e.g., pending changes in a state of a traffic light, obstacles at or near the intersection, or other situation in which it may be difficult for an operator of the vehicle to see what is occurring at the intersection). As used herein, a roadway device may refer to roadside infrastructure (e.g., a roadside unit (RSU) or roadside equipment (RSE)), a vehicle, or any device participating in roadway traffic. As another example, vehicles may operate to communicate with each other so to signal an intent of their next operation. As an illustrative example, one vehicle may be comping to a stop and communicate this intent (e.g., action) to other vehicles in the area so the other vehicles can operate with this information.

However, conventional communications between roadway devices could be subject to spoofing of the information and/or the source of the information. For example, a malicious actor may place a transmitter by a roadway and spoof information transmitted, claiming to be from a vehicle, which may cause other vehicles to react in a way that negatively impacts traffic flow and/or safety. As another example, the malicious actor may spoof the existence of another vehicle, for example, at an intersection that may cause an autonomous or semi-autonomous vehicle to behave in an adverse way. For example, the autonomous or semi-autonomous vehicle may come to an unintended stop that blocks traffic or may perform some other action that causes a disturbance.

Accordingly, aspects of the present disclosure leverage a proxy device, which is separate and distinct from vehicle, located within the vehicle or otherwise associated with the physical area of the vehicle to authenticate the vehicle with other roadway devices. The proxy device can be configured to authenticate the vehicle and authenticate other roadway devices communicable connected to the vehicle. In examples, the roadway devices may also authenticate the proxy device and determine a geographic location of a proxy device. If the geographic location of the proxy device matches that of the vehicle, within a set threshold, the roadway device can use the proxy device as a proxy of the vehicle, such that authentication of the proxy device can be extended to the vehicle. Geographic location of the proxy device may be provided by a Global Positioning System (GPS) in some examples. However, GPS signals can likewise be spoofed. Thus, in various examples, the geographic location of the proxy device may be obtained using cellular network tower data and triangulation techniques.

In some examples, authentication may be performed using public key infrastructure (PKI) (e.g., asymmetric public-private key pairs). Alternatively, authentication could be performed by cross-references personal data (e.g., owner of the proxy device with a vehicle identification number (VIN) of the vehicle), but such an approach could expose personal information. Thus, PKI infrastructure may be utilized to bind an identifier of a device (e.g., a device identification, MAC address or the like) and a private key associated with the proxy device. For example, an identifier of the proxy device can be bound to its private key, an identifier of the vehicle (e.g., VIN) can be bound to its private key, and an identifier of the roadway device can be bound to its private key. In various examples, identifier of the proxy device can be bound to, not only its private key, but also to the private key of a vehicle associated with the proxy device, the vehicle identifier, and the common geographic location of the vehicle and proxy device. Accordingly, communications from the various device may be encrypted using a respective private key and then decrypted by a receiving device using the corresponding public key.

Another aspect of the disclosed technology is that examples herein can communicate information characterizing conditions to only those vehicles that need such information for navigating the environment, and not to all vehicles in the vicinity. For example, referring to the intersection example above, there may be an obstacle at the intersection affecting eastbound traffic, but not westbound traffic. A roadway device (e.g., a vehicle, RSU, or the like) may detect the obstacle and operate to inform only those vehicles traveling along the eastbound roadway. In one example, the roadway device may identify eastbound vehicles, for example, by utilizing cameras to read license plates, exchanging geographic location information, etc. Once the set of vehicles are identified, proxy devices contained in each of the set of vehicles can be used to authenticate the vehicles and authenticate the roadway device, as described above. Upon authenticating the set of vehicles via the proxy devices, the roadway device may then communicate the information to each of the set of vehicles. In one example, the roadway device may broadcast the information encrypted using public keys of each vehicle, which can be decrypted only at the set of vehicles using respective private keys. In another example, the roadway device may transmit the information using a narrow beam (e.g., a laser) to each of the set vehicles such that only those vehicles receive the information.

The systems and methods disclosed herein may be used to authenticate communications that can be utilized to control (operate and guide) one or more vehicles along a roadway. For example, information can be exchanged between roadway devices, such as vehicles, RSU/RSE, etc., that informs roadway participants on environmental conditions. Based on this information, the vehicle can be operated, either manually by a driver or autonomously/semi-autonomously, to navigate the environment or to maneuver the vehicle in a safe manner through the environment.

As used herein, the words “geographic location,” “location,” “geographic position”, and “position” refer to a latitude and longitude of an object (or, a latitude, longitude, and elevation of an object), such as a connected vehicle, an RSU/RSE, a client device, etc. As used herein, the words “geographic area”, “physical area”, and “area,” refer to a physical space surrounding a geographic location (e.g., an area of defined space surrounding a geographic location or position).

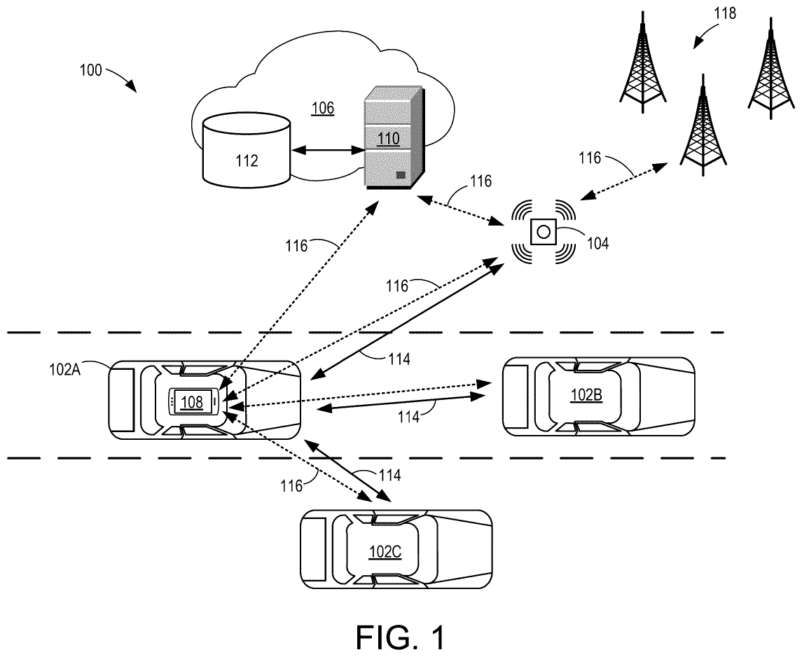

FIG. 1 illustrates an example vehicular communication authentication system 100 in accordance with various embodiments disclosed herein. The system 100 includes at least one proxy device 108, one or more vehicles 102A-102C, one or more roadside units or other infrastructure devices 104 and a cloud or edge server 110. These elements of the system 100 may be communicatively coupled to network 106. The one or more vehicles 102A-102B may each provide similar functionality and are referred to herein “vehicle 102” individually or collectively. The one or more roadside units or other infrastructure devices 104 may provide similar functionality and are referred to herein as “RSU 104” individually or collectively. Vehicles 102 and RSU 104 may be each be an example of a roadway device because each device is participating (e.g., sensing, controlling, navigating, etc.) in roadway traffic. In example herein, vehicle communications 114 exchanged between the roadway devices and vehicle 102A can be authenticated using proxy device 108 via authentication communications 116. The proxy device 108 may be disposed within the vehicle 102A (e.g., in a cabin) or otherwise disposed anywhere within the same physical location as the vehicle 102A.

A vehicle 102 may have one or more sensors (not shown in FIG. 1), e.g., vehicle operating conditions, external sensors, in-cabin sensors, and the like. For example, a vehicle 102A may have proximity sensors that can gather data regarding nearby objects or other vehicles, e.g., vehicles 102B and 102C. Vehicle operating condition sensors can gather data regarding vehicle states of operation and conditions. Data collected by these sensors may be referred to as “vehicle-related data.” Environmental condition sensors can gather data regarding conditions in an environment in which the vehicle is traveling. Data collected by these sensors may be referred to as “environment-related data.”

According to various embodiments, vehicles 102 can be autonomous vehicles. As used herein, “autonomous vehicle” can refer to a vehicle that is configured to operate in an autonomous operational mode. “Autonomous operational mode” can refer to the use of one or more computing systems of the vehicle 102 to navigate and/or maneuver vehicle 102 along a travel route with a level of input from a human driver which can vary with the operational mode. As such, vehicle 102 can have a plurality of autonomous operational modes. In some embodiments, vehicle 102 can have an unmonitored autonomous operational mode, meaning that one or more computing systems are used to maneuver vehicle 10 along a travel route fully autonomously, requiring no input or supervision required from a human driver.

Alternatively, or in addition to the above-described modes, vehicles 102 can have one or more semi-autonomous operational modes. “Semi-autonomous operational mode” can refer to a mode whereby a portion of the navigation and/or maneuvering of vehicle 102 along a travel route is performed by one or more computing systems, and a portion of the navigation and/or maneuvering of vehicle 102 along a travel route is performed by a human driver. One example of a semi-autonomous operational mode is when an adaptive cruise control system is activated. In such case, the speed of vehicle 102 can be automatically adjusted to maintain a safe distance from a vehicle ahead based on data received from on-board sensors, but vehicle 102 is otherwise operated manually by a human driver. Upon receiving a driver input to alter the speed of the vehicle (e.g., by depressing the brake pedal to reduce the speed of the vehicle 102), the adaptive cruise control system can be deactivated, and the speed of the vehicle is reduced. Other semi-autonomous operational modes, which may be implemented alone or in combination (e.g., with other operational modes including adaptive cruise control), may include, but not limited to, a lane-keeping operational mode, automated navigation, and the like.

Vehicles 102 may further have vehicle-to-everything (V2X) communications capabilities, allowing vehicle 102 to communicate with a roadside unit/equipment (RSU/RSE) or other roadside infrastructure, such as RSU 104 (which may be a vehicle-to-infrastructure (V2I)-enabled streetlight or cameras, for example). Vehicles 102 may also communicate with other vehicles over vehicle-to-vehicle (V2V) communications. Data gathered by a vehicle 102, either through its own sensors, or other data sources, e.g., RSU 104 and/or other vehicles, may be ultimately be transmitted to other vehicles, RSU 104, and/or a network edge device, such as the cloud, e.g., a cloud server 110 and cloud-based database 112 resident on network 106, via vehicle communications 144.

The proxy device 108 may be any device operated by a user and configured for wireless communication via network 106. The proxy device 108 may be, for example but not limited to, a mobile phone, a desktop computer, a laptop computer, a tablet computer, a netbook computer, a wearable smart device (e.g., smartwatches, smart rings, and the like), a smart phone, a smart terminal, and the like. The proxy device 108 may also be referred to as a client device or unit equipment (UE). In some examples, the proxy device 108 may be configured for wireless communication with one other device via one or more of the following: Wi-Fi; cellular communication including 3G, 4G, LTE, 5G, etc. ; Dedicated Short Range Communication (DSRC); millimeter wave communication; Bluetooth®; near field communications (NFC); Zigbee, and any of a number of other wireless communication protocols whether standardized, proprietary, open, point-to-point, networked or otherwise. In some examples, proxy device 108 may utilize cellular communications provided by a cellular network 118, consisting of a plurality of cellular towers.

In examples, the proxy device 108 can be a distinct device that is separate from the vehicle 102 itself, but otherwise located within the vehicle 102 or otherwise associated with the physical area of the vehicle 102. Thus, due to the shared space, the proxy device 108 can be considered, by other roadway device, a proxy of the vehicle to which the proxy device is associated with. Accordingly, examples herein may utilize the proxy device 108 to authenticate vehicle communications 114 from the vehicle 102A by serving to authenticate the vehicle 120A with the other roadway devices, e.g., vehicles 102B and/or 102C, RSU 104, etc. The proxy device 108 also function to authenticate vehicle communications 114 received by vehicle 102A from the other roadway devices, for example, by authenticating the other roadway devices. Said another way, proxy device 108 may function to establish trust in the vehicle 102A with other roadway devices and vice versa.

In examples, the roadway devices may authenticate the proxy device 108 and determine a geographic location of a proxy device 108. If the geographic location of the proxy device 108 is within the physical area of the vehicle 102A, within a set threshold, the roadway device may consider the proxy device 108 as a proxy for vehicle 102A. Thus, by authenticating the proxy device 108 and determining the proxy device 108 is associated with the vehicle 102A (e.g., the proxy device 108 is located within the physical area of the vehicle 102A), the roadway device can extend the authentication of the proxy device to the vehicle 102A, thereby trusting the vehicle communications 114 exchanged therewith.

Roadway devices may determine the geographic location of the proxy device 108 by any desired technique. For example, GPS coordinates of the proxy device 108 may be obtained and a geographic location resolved therefrom. However, GPS signals can be spoofed and may not be trustworthy. Accordingly, in some examples, the roadway device may obtain a geographic location of the proxy device 108 using cellular network tower data obtained from a plurality of towers of cellular network 118 and determine a location using triangulation techniques. For example, as shown in FIG. 1, the RSU 104 may be exchanging communications 114 with vehicle 102A. Upon authenticating the proxy device 108, the RSU 104 may obtain geographic location information from a plurality of towers of cellular network 118 and execute triangulation techniques to determine a geographic location for the proxy device 108. RSU 104 may compare the geographic location of proxy device 108 with the physical area of the vehicle 102A (e.g., a current geographic area of the vehicle 102A) and determine that the proxy device 108 is representative (e.g., a proxy) of the vehicle 102A if the location of proxy device 108 lies overlaps with or otherwise lies with the physical area of the vehicle 102A.

In some examples, authentication may be performed by cross-references personal data of the proxy device 108 and vehicle 102A. For example, the RSU 104 may obtain a VIN of the vehicle 102A and an owner of the vehicle via authentication communication 116 with server 110. This personal information may be crossed reference against, for example, an identifier of the proxy device 108 (e.g., International Mobile Equipment Identity Number (IMEI), mobile identification number (MIN), or the like) and the owner of the proxy device 108. If the owner of the proxy device 108 and the owner of the vehicle 102A match, then RSU 104 may authenticate the vehicle communications 114.

However, the above approach may expose personal information to malicious actors. Accordingly, in some examples, authentication may be performed using PKI via authentication communications 116 to bind an identifier of the proxy device 108 (e.g., a device identification, MAC address or the like) with a private key associated with the proxy device 108, for example, as a root digital certificate. The proxy device 108 may then sign a binding (e.g., a digital certificate) of an identifier of the vehicle 102A (e.g., VIN) and the private key of the vehicle 102A. Thus, the roadway device, through PKI, may authenticate the proxy device 108 and decrypt the binding using a public key of the proxy device 108 to obtain a public key of the vehicle 102A, which can ensure trust in the vehicle communications 114 (e.g., by decrypting subsequent communications using the obtained public key of the vehicle 102A).

In some examples, the binding of identifier of the vehicle 102A (e.g., VIN) and the private key of the vehicle 102A may include the physical area of the vehicle 102A. The physical area may be obtained by the vehicle 102A via GPS or any other localization system. In this example, the RSU 104 may decrypt an authentication communication 116 from the proxy device 108, which contains the binding of identifier of the vehicle 102A with the private key and the physical area of the vehicle 102A, using the public key of the proxy device 108 to obtain the public key and the physical area of the vehicle 102A. RSU 104 may then compare the geographic location of the proxy device 108, obtained as described above, against the physical area to authenticate the vehicle 102A itself.

Similarly, the proxy device 108 may obtain an identifier of the RSU 104 can be bound to its private key. Thus, the proxy device 108 can authenticate the RSU 104 using its public key and provide the RSU's public key to the vehicle for use in decrypting vehicle communications 114. In this case, the vehicle communications may be encrypted using the vehicle's private key or the RSU's private key, depending on which device is sending the communication.

In some examples, information characterizing conditions may be communicated to only those vehicles 102 that need such information for navigating the environment, and not to all vehicles in the vicinity. For example, referring to FIG. 1, there may be an obstacle in the lane affecting vehicles 102A and 10B, but not in the lane in which vehicle 102C is traveling. RSU 104 (and/or any vehicle 102) may detect the obstacle and attempt to exchange vehicle communications 114 with only those vehicles traveling in the relevant lane. In one example, the RSU 104 may identify vehicles 102A and 102B, for example, by utilizing cameras to read license plates, exchanging geographic location information, etc. Once the set of vehicles 102A and 102B are identified, RSU 104 may exchange authentication communications 116 with proxy devices (e.g., proxy device 108) associated with each of the vehicles 102A and 102B to authenticate the respective vehicles. The proxy devices may also authenticate the RSU 104, as described above. Upon authenticating the vehicles 102A and 102B, the RSU 104 may transmit the information to each vehicle 102A and 120B via vehicle communications 114. In one example, the RSU 104 may broadcast the information encrypted using public keys of each vehicle 102A and 10B, which can be decrypted only by vehicles 102A and 102N using respective private keys. In another example, the RSU 104 may transmit the information using a targeted narrow beam (e.g., a laser) that sends vehicle communications only to vehicles 102A and 102B.

Upon authenticating devices and exchanging vehicle communications, vehicles 102 and/or RSU 104 may utilize the information to control (operate and guide) one or more vehicles 102 along the roadway. For example, information can inform vehicles 102 on environmental conditions. Based on this information, the vehicles 102 can be operated, either manually or autonomously/semi-autonomously, to navigate the environment or to maneuver the vehicle in a safe manner through the environment.

While the above examples are provided with reference to RSU 104, the present disclosure is not limited to vehicle to RSU communications. RSU 104 may be switched with any roadway device as described herein. Thus, for example, vehicle 102A may communicate with vehicle 102B in an example, and the authentication occurring as set forth above. Vehicle 102B may also comprise a proxy device that is substantially similar to proxy device 108 and configured to authenticate vehicle 102B with respect to vehicle 102A in a manner similar to that described above.

Server 110 may be an edge server or a cloud server. For example, server 110 may be an edge server implemented as a processor-based computing device installed in a roadside infrastructure or some other processor-based infrastructure component of a roadway. Some embodiments can implement edge case handling and redundancy measures. For example, the system can add alternative location verification methods or multi-factor authentication in situations where GPS-based authentication fails. While a cloud server may be one or more cloud-based instances of processor-based computing device residents on network 106. Server 110 may include circuitry to control various aspects of the vehicular communication authentication described herein. Server 110 may include, for example, a microcomputer that includes a one or more processing units (e.g., microprocessors), memory storage (e.g., RAM, ROM, etc.), and I/O devices. The server 110 may store information related to authenticating roadway devices in a cloud-based database 112, which may be resident on network 106. For example, server 110 may store identifiers and other information used for authenticating devices. In the case of PKI implementations, server 110 may be a certificate authority and/or a registration authority having access to public keys of devices. The processing units of cloud server 110, execute instructions stored in memory to execute and control functions of the system 100, for example, as described below in connection with FIGS. 1-4.

Network 106 may be a conventional type of network, wired or wireless, and may have numerous different configurations including a star configuration, token ring configuration, or other configurations. Furthermore, the network 106 may include a local area network (LAN), a wide area network (WAN) (e.g., the Internet), or other interconnected data paths across which multiple devices and/or entities may communicate. In some embodiments, the network 106 may include a peer-to-peer network. The network 106 may also be coupled to or may include portions of a telecommunications network for sending data in a variety of different communication protocols. In some embodiments, the network 106 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network 106 may also include a mobile data network that may include 3G, 4G, 5G, LTE, LTE-V2V, LTE-V2I, LTE-V2X, LTE-D2D, VoLTE, 5G-V2X or any other mobile data network or combination of mobile data networks. Further, the network 105 may include one or more IEEE 802.11 wireless networks.

In some embodiments, the network 106 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc. ; Dedicated Short Range Communication (DSRC); millimeter wave communication; etc.

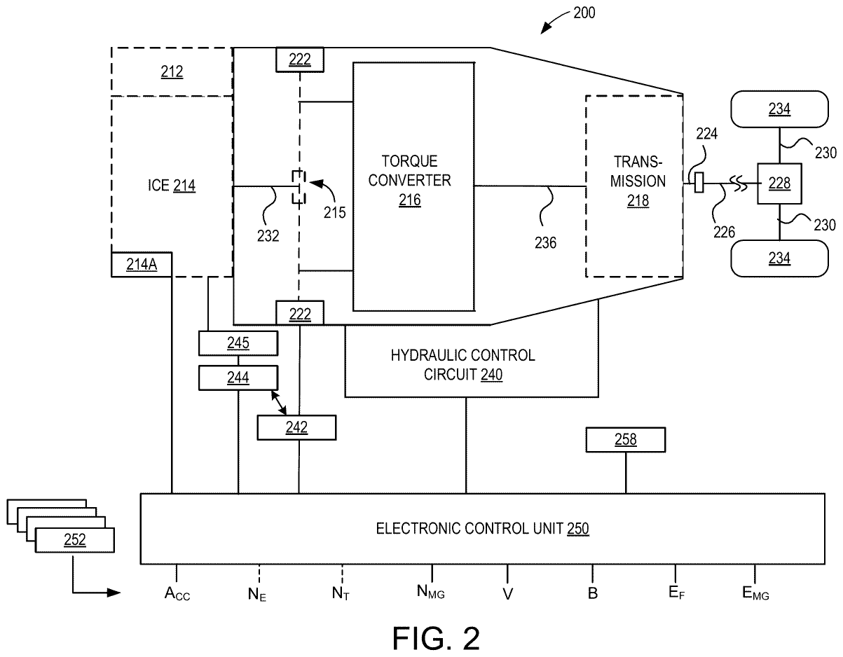

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 2. Although the example described with reference to FIG. 2 is a hybrid type of vehicle, the systems and methods for authentication of vehicular communications can be implemented in other types of vehicles including gasoline-or diesel-powered vehicles, fuel-cell vehicles, electric vehicles, or other vehicles.

FIG. 2 illustrates a drive system of an example vehicle 200 that may include an internal combustion engine 214 and one or more electric motors 222 (which may also serve as generators) as sources of motive power. Driving force generated by the internal combustion engine 214 and motors 222 can be transmitted to one or more wheels 234 via a torque converter 216, a transmission 218, a differential gear device 228, and a pair of axles 230.

As an HEV, vehicle 200 may be driven/powered with either or both of engine 214 and the motor(s) 222 as the drive source for travel. For example, a first travel mode may be an engine-only travel mode that only uses internal combustion engine 214 as the source of motive power. A second travel mode may be an EV travel mode that only uses the motor(s) 222 as the source of motive power. A third travel mode may be an HEV travel mode that uses engine 214 and the motor(s) 222 as the sources of motive power. In the engine-only and HEV travel modes, vehicle 200 relies on the motive force generated at least by internal combustion engine 214, and a clutch 215 may be included to engage engine 214. In the EV travel mode, vehicle 200 is powered by the motive force generated by motor 222 while engine 214 may be stopped and clutch 215 disengaged.

Engine 214 can be an internal combustion engine such as a gasoline, diesel or similarly powered engine in which fuel is injected into and combusted in a combustion chamber. A cooling system 212 can be provided to cool the engine 214 such as, for example, by removing excess heat from engine 214. For example, cooling system 212 can be implemented to include a radiator, a water pump and a series of cooling channels. In operation, the water pump circulates coolant through the engine 214 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 214. In other applications, either or both the water pump and the fan may be operated by electric current such as from battery 244.

An output control circuit 214A may be provided to control drive (output torque) of engine 214. Output control circuit 214A may include a throttle actuator to control an electronic throttle valve that controls fuel injection, an ignition device that controls ignition timing, and the like. Output control circuit 214A may execute output control of engine 214 according to a command control signal(s) supplied from an electronic control unit 250, described below. Such output control can include, for example, throttle control, fuel injection control, and ignition timing control.

Motor 222 can also be used to provide motive power in vehicle 200 and is powered electrically via a battery 244. Battery 244 may be implemented as one or more batteries or other power storage devices including, for example, lead-acid batteries, nickel-metal hydride batteries, lithium-ion batteries, capacitive storage devices, and so on. Battery 244 may be charged by a battery charger 245 that receives energy from internal combustion engine 214. For example, an alternator or generator may be coupled directly or indirectly to a drive shaft of internal combustion engine 214 to generate an electrical current as a result of the operation of internal combustion engine 214. A clutch can be included to engage/disengage the battery charger 245. Battery 244 may also be charged by motor 222 such as, for example, by regenerative braking or by coasting during which time motor 222 operate as generator.

Motor 222 can be powered by battery 244 to generate a motive force to move the vehicle and adjust vehicle speed. Motor 222 can also function as a generator to generate electrical power such as, for example, when coasting or braking. Battery 244 may also be used to power other electrical or electronic systems in the vehicle. Motor 222 may be connected to battery 244 via an inverter 242. Battery 244 can include, for example, one or more batteries, capacitive storage units, or other storage reservoirs suitable for storing electrical energy that can be used to power motor 222. When battery 244 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 250 (described below) may be included and may control the electric drive components of the vehicle as well as other vehicle components. For example, electronic control unit 250 may control inverter 242, adjust driving current supplied to motor 222, and adjust the current received from motor 222 during regenerative coasting and breaking. As a more particular example, output torque of the motor 222 can be increased or decreased by electronic control unit 250 through the inverter 242.

A torque converter 216 can be included to control the application of power from engine 214 and motor 222 to transmission 218. Torque converter 216 can include a viscous fluid coupling that transfers rotational power from the motive power source to the driveshaft via the transmission. Torque converter 216 can include a conventional torque converter or a lockup torque converter. In other embodiments, a mechanical clutch can be used in place of torque converter 216.

Clutch 215 can be included to engage and disengage engine 214 from the drivetrain of the vehicle. In the illustrated example, a crankshaft 232, which is an output member of engine 214, may be selectively coupled to the motor 222 and torque converter 216 via clutch 215. Clutch 215 can be implemented as, for example, a multiple disc type hydraulic frictional engagement device whose engagement is controlled by an actuator such as a hydraulic actuator. Clutch 215 may be controlled such that its engagement state is complete engagement, slip engagement, and complete disengagement complete disengagement, depending on the pressure applied to the clutch. For example, a torque capacity of clutch 215 may be controlled according to the hydraulic pressure supplied from a hydraulic control circuit (not illustrated). When clutch 215 is engaged, power transmission is provided in the power transmission path between the crankshaft 232 and torque converter 216. On the other hand, when clutch 215 is disengaged, motive power from engine 214 is not delivered to the torque converter 216. In a slip engagement state, clutch 215 is engaged, and motive power is provided to torque converter 216 according to a torque capacity (transmission torque) of the clutch 215.

As alluded to above, vehicle 200 may include an electronic control unit 250. Electronic control unit 250 may include circuitry to control various aspects of the vehicle operation. Electronic control unit 250 may include, for example, a microcomputer that includes a one or more processing units (e.g., microprocessors), memory storage (e.g., RAM, ROM, etc.), and I/O devices. The processing units of electronic control unit 250, execute instructions stored in memory to control one or more electrical systems or subsystems 258 in the vehicle. Electronic control unit 250 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units or using a single electronic control unit.

In the example illustrated in FIG. 2, electronic control unit 250 receives information from a plurality of sensors included in vehicle 200. For example, electronic control unit 250 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 214 (engine RPM), a rotational speed, NMG, of the motor 222 (motor rotational speed), and vehicle speed, NV. These may also include torque converter 216 output, NT (e.g., output amps indicative of motor output), brake operation amount/pressure, B, battery SOC (i.e., the charged amount for battery 244 detected by an SOC sensor). Accordingly, vehicle 200 can include a plurality of sensors 252 that can be used to detect various conditions internal or external to the vehicle and provide sensed conditions to engine control unit 250 (which, again, may be implemented as one or a plurality of individual control circuits). In one embodiment, sensors 252 may be included to detect one or more conditions directly or indirectly such as, for example, fuel efficiency, EF, motor efficiency, EMG, hybrid (internal combustion engine 214+MG 212) efficiency, acceleration, ACC, etc.

In some embodiments, one or more of the sensors 252 may include their own processing capability to compute the results for additional information that can be provided to electronic control unit 250. In other embodiments, one or more sensors may be data-gathering-only sensors that provide only raw data to electronic control unit 250. In further embodiments, hybrid sensors may be included that provide a combination of raw data and processed data to electronic control unit 250. Sensors 252 may provide an analog output or a digital output.

Sensors 252 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 200, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 2 is provided for illustration purposes only as one example of vehicle systems with which embodiments of the disclosed technology may be implemented. One of ordinary skill in the art reading this description will understand how the disclosed embodiments can be implemented with this and other vehicle platforms.

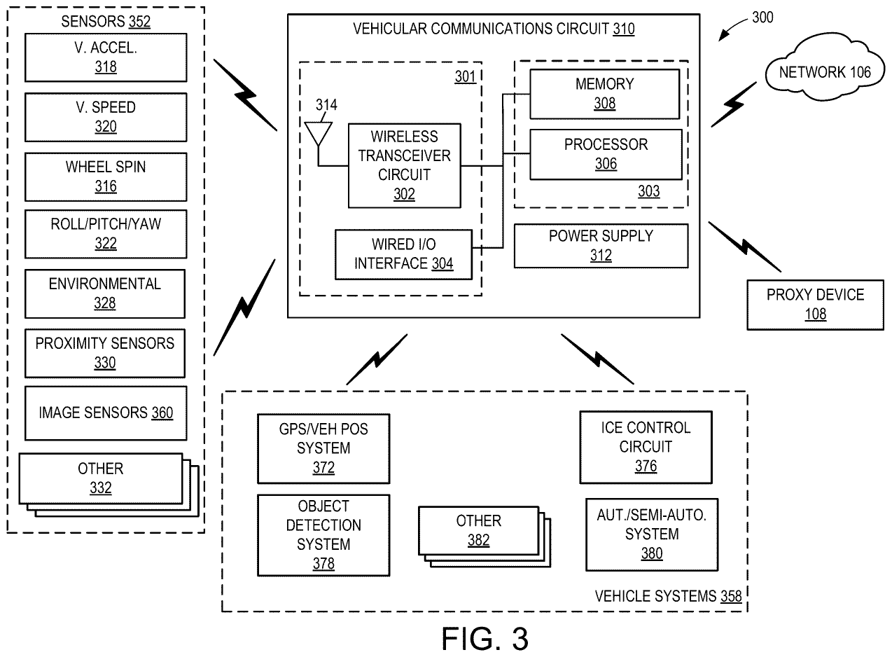

FIG. 3 illustrates an example architecture for authenticating vehicle communications in accordance with one embodiment of the systems and methods described herein. Referring now to FIG. 3, in this example, vehicular communication system 300 includes a vehicular communications circuit 310, a plurality of sensors 352 and a plurality of vehicle systems 358. Sensors 352 (such as sensors 252 described in connection with FIG. 2) and vehicle systems 358 (such as subsystems 258 described in connection with FIG. 2) can communicate with vehicular communications circuit 310 via a wired or wireless communication interface. Although sensors 352 and vehicle systems 358 are depicted as communicating with vehicular communications circuit 310, they can also communicate with each other as well as with other vehicle systems. Vehicular communications circuit 310 can be implemented as an ECU or as part of an ECU such as, for example electronic control unit 250. In other embodiments, vehicular communications circuit 310 can be implemented independently of the ECU.

Vehicular communications circuit 310 in this example includes a communication circuit 301, a decision circuit 303 (including a processor 306 and memory 308 in this example) and a power supply 312. Components of vehicular communications circuit 310 are illustrated as communicating with each other via a data bus, although other communication in interfaces can be included. Processor 306 can include one or more GPUs, CPUs, microprocessors, or any other suitable processing system. Processor 306 may include a single core or multicore processors. The memory 308 may include one or more various forms of memory or data storage (e.g., flash, RAM, etc.) that may be used to store instructions and variables for processor 306 as well as any other suitable information, such as, one or more of the following elements: vehicle-related data, environmental-related data, public and private key pair of the circuit 310, public keys of connected roadway devices, and other data for operating in accordance with the examples herein. Memory 308 can be made up of one or more modules of one or more different types of memory and may be configured to store data and other information as well as operational instructions that may be used by the processor 306 to vehicular communications circuit 310.

Although the example of FIG. 3 is illustrated using processor and memory circuitry, as described below with reference to circuits disclosed herein, decision circuit 303 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a vehicular communications circuit 310.

Communication circuit 301 includes either or both a wireless transceiver circuit 302 with an associated antenna 314 and a wired I/O interface 304 with an associated hardwired data port (not illustrated). Communication circuit 301 can provide for vehicle-to-everything (V2X) and/or vehicle-to-vehicle (V2V) communications capabilities, allowing vehicular communications circuit 310 to communicate with edge devices, such as roadside unit/equipment (RSU/RSE), network cloud servers and cloud-based databases, and/or other vehicles via network 106. For example, V2X communication capabilities allows vehicular communications circuit 310 to communicate with edge/cloud servers, roadside infrastructure (e.g., such as roadside equipment/roadside unit, which may be a vehicle-to-infrastructure (V2I)-enabled street light or cameras, for example), etc. vehicular communications circuit 310 may also communicate with other connected vehicles over vehicle-to-vehicle (V2V) communications.

As this example illustrates, communications with vehicular communications circuit 310 can include either or both wired and wireless communications circuits 301. Wireless transceiver circuit 302 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by vehicular communications circuit 310 to/from other entities such as sensors 352 and vehicle systems 358.

Wired I/O interface 304 can include a transmitter and a receiver (not shown) for hardwired communications with other devices. For example, wired I/O interface 304 can provide a hardwired interface to other components, including sensors 352 and vehicle systems 358. Wired I/O interface 304 can communicate with other devices using Ethernet or any of a number of other wired communication protocols whether standardized, proprietary, open, point-to-point, networked or otherwise.

Power supply 312 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 352 can include, for example, sensors 252 such as those described above with reference to the example of FIG. 2, which can be configured to collect sensor data (e.g., vehicle-and/or environmental-related data). Sensors 352 can include additional sensors that may or may not otherwise be included on a standard vehicle with which the vehicular communication system 300 is implemented. In the illustrated example, sensors 352 include vehicle acceleration sensors 318, vehicle speed sensors 320, wheelspin sensors 316 (e.g., one for each wheel), accelerometers such as a 3-axis accelerometer 322 to detect roll, pitch and yaw of the vehicle, environmental sensors 328 (e.g., to detect salinity or other environmental conditions), and proximity sensor 330 (e.g., sonar, radar, lidar or other vehicle proximity sensors). Additional sensors 332 can also be included as may be appropriate for a given implementation of vehicular communication system 300.

System 300 may be equipped with one or more image sensors 360. These may include front facing image sensors, side facing image sensors, and/or rear facing image sensors. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultraviolet spectrum, etc. Image sensors 360 can be used to, for example, to detect objects in an environment surrounding a vehicle comprising vehicular communication system 300, for example, surrounding vehicles, roadway environment, road lanes, road curvature, obstacles, and so on. For example, a one or more image sensors 360 may capture images of surrounding vehicles in the surrounding environment. As another example, object detecting and recognition techniques may be used to detect objects and environmental conditions, such as, but not limited to, road conditions, surrounding vehicle behavior (e.g., driving behavior and the like), and the like. Additionally, sensors may estimate proximity between vehicles. For instance, the image sensors 360 may include cameras that may be used with and/or integrated with other proximity sensors 330 such as LIDAR sensors or any other sensors capable of capturing a distance. As used herein, a sensor set of a vehicle may refer to sensors 352.

Vehicle systems 358, for example, systems and subsystems 258 described above with reference to the example of FIG. 2, can include any of a number of different vehicle components or subsystems used to control or monitor various aspects of the vehicle and its performance. In this example, the vehicle systems 358 includes a vehicle positioning system 372 that can be used to obtain a geographic location for the vehicle; engine control circuits 376 to control the operation of engine (e.g. internal combustion engine 214 and/or motors 222); object detection system 378 to perform image processing such as object recognition and detection on images from image sensors 360, proximity estimation, for example, from image sensors 360 and/or proximity sensors, etc. for use in other vehicle systems; and other vehicle systems 382 (e.g., Advanced Driver-Assistance Systems (ADAS), autonomous or semi-autonomous driving systems 380, such as forward/rear collision detection and warning systems, pedestrian detection systems, autonomous or semi-autonomous driving systems, and the like).

Autonomous or semi-autonomous driving systems 380 can be operatively connected to the various vehicle systems 358 and/or individual components thereof. For example, autonomous or semi-autonomous driving systems 380 can send and/or receive information from the various vehicle systems 358 to control the movement, speed, maneuvering, heading, direction, etc. of the vehicle. The autonomous or semi-autonomous driving systems 380 may control some or all of these vehicle systems 358 and, thus, may be semi-or fully autonomous.

As described above in connection with FIG. 1, the network 160 can include a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc. ; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VoLTE); etc. In some examples, the V2X communications can include V2V communications, Vehicle-to-Infrastructure (V2I) communications, Vehicle-to-Network (V2N) communications or any combination thereof.

Examples of a wireless message (e.g., a V2X wireless message) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 5G-V2X message; and a millimeter wave message, etc.

During operation, communication circuit 301 can be used to transmit and receive information between circuit 310 and sensors 252, and circuit 310 and vehicle systems 258. Also, sensors 252 may communicate with vehicle systems 258 directly or indirectly (e.g., via communication circuit 301 or otherwise). In various examples, the communication circuit 301 may also be used to transmit and receive information between circuit 310 and proxy device 108, as well as between other roadway devices via network 106.

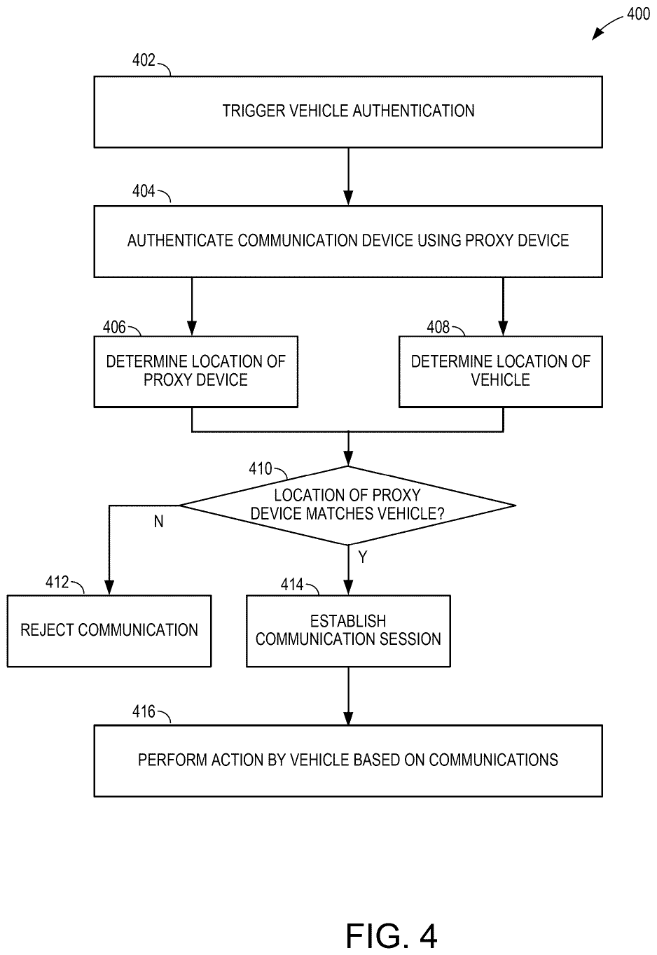

FIG. 4 is a flow chart illustrating example operations for authenticating vehicular communications in accordance with various embodiments disclosed herein. FIG. 4 provides a process 400 for authenticating vehicle communications through the use of a proxy device (e.g., proxy device 108 of FIG. 1). Process 400 may be implemented as instructions, for example, stored on vehicular communications circuit 310, that when executed by one or more processors perform one or more operations of process 400. In another example, process 400 may be implemented as instructions stored on a proxy device, that when executed by one or more processors performs one or more operations of process 400. The process 400 will be described below with reference to FIG. 3 as an illustrative example. While FIG. 4 depicts process 400 as operations arranged in an example sequence, one of ordinary skill in the art will appreciate that their various alternative sequences that may be without confinement to the illustrated example. Operations can be performed in any desired order unless a particular order is otherwise explicitly required herein.

At operation 402, vehicle authentication is triggered. For example, a vehicle (e.g., vehicle 102A of FIG. 1) may be approaching a scenario (e.g., intersection or other roadway environment) and obtain vehicle-and/or environmental-related data that it may seek to provide to other roadway devices (e.g., other vehicles and/or RSU 104 of FIG. 1). In another example, a roadway device may seek to transmit vehicle-and/or environmental-related data to vehicle 102A, thereby trigging a need to authenticate the vehicle and roadway devices.

In another example, as described above in connection with FIG. 1, a roadway device may identify vehicle 102A as a part of a set of vehicles for which vehicle communications (e.g., communications 114 of FIG. 1) are to be directed.

In either case, based on operation 402 (e.g., in response to), the vehicle can be authenticated using the proxy device (e.g., proxy device 108) at operation 404. For example, the proxy device may operate to establish trust in vehicle communications from the vehicle by authenticating the vehicle 120A with the other roadway devices, as well as authenticating vehicle communications received by the vehicle from the other roadway devices. In some examples, operation 402 may be performed by cross-referencing personal data of the proxy device and vehicle. If the owner of the proxy device and the owner of the vehicle match, then the vehicle communications from the vehicle may be trusted. Similarly, personal information of the other roadway devices may be cross-referenced for authentication.

In an illustrative example, operation 402 may be performed using PKI via authentication communications (e.g., communications 416 above) to bind an identifier of the proxy device with a private key associated with the proxy device, for example, as a root digital certificate. The proxy device may sign a binding (e.g., a digital certificate) of an identifier of the vehicle and the private key of the vehicle. Thus, the roadway device, through PKI, may authenticate the proxy device and decrypt the binding using a public key of the proxy device to obtain a public key of the vehicle, which can ensure trust in the vehicle communications.

In any event, once the vehicle and roadway devices are authenticated via the proxy device at operation 404, the geographic location of the proxy device can be used to further verify that the vehicle is the entity it claims to be. For example, at operation 406 the geographic location of the proxy device can be obtained and at operation 408 the geographic location of the vehicle can be obtained. In some examples, the roadway device may obtain the geographic location of the proxy device based on location data received from external sources (e.g., cellular network towers). Similarly, roadway devices may obtain the location of the vehicle, for example, from GPS coordinates. In some embodiments, anomaly detection can be incorporated into the location data to reduce the risk of GPS spoofing.

At operation 410, a determination can be as to whether or not the proxy device is at the same location as the vehicle. In some examples, a threshold distance from the location of the vehicle obtained at operation 408 may define a geographic area of the vehicle. For example, an area having a radius of 5 feet from the geographic location may be considered the geographic area of the vehicle. Other distances may be selected as desired to correspond and cover at least the interior cabin of the vehicle. If the location of proxy device obtained in operation 406 falls within the geographic area, then the location of the proxy device can be considered the same as the location of the vehicle. In another example, the geographic area of the vehicle may be based on physical dimension of the vehicle that can be used to define a geographic area around the location obtained at operation 408.

In examples using PKI, the binding of identifier of the vehicle and the private key of the vehicle may include the geographic area of the vehicle. In this case, the roadway device may decrypt an authentication communication from the proxy device, which contains the binding of identifier of the vehicle with the private key and the geographic area of the vehicle, using the public key of the proxy device. Through the decryption, the public key and the geographic area of the vehicle can be obtained. RSU Then at operation 410, the geographic location of the proxy device, obtained as described above, can be compared against the geographic area to verify trustworthiness of the vehicle.

If the location of the proxy device 408 does not match the location of the vehicle (e.g., NO at operation 410), then vehicle communications received from vehicle can be rejected, dropped or otherwise discarded at operation 412. That is, if there is not a match (or authentication at operation 404 fails) the vehicle communications cannot be trusted and thus are not to be utilized for vehicular operations.

Otherwise, if operation 410 is affirmative, then a communication session can be established between the vehicle and the roadway devices for exchanging vehicle communications at operation 414. As described above, vehicle communications may include vehicle-and/or environmental-related data that may characterize conditions of the environment in which the vehicle is traveling. As such, at operation 416, the vehicle can be operated, either manually or autonomously/semi-autonomously, to navigate the environment and maneuver the vehicle in a safe manner through the environment. For example, operation 416 may send information to autonomous or semi-autonomous driving systems 308 for controlling the vehicle in an autonomous or semi-autonomous manner according to the environmental conditions.

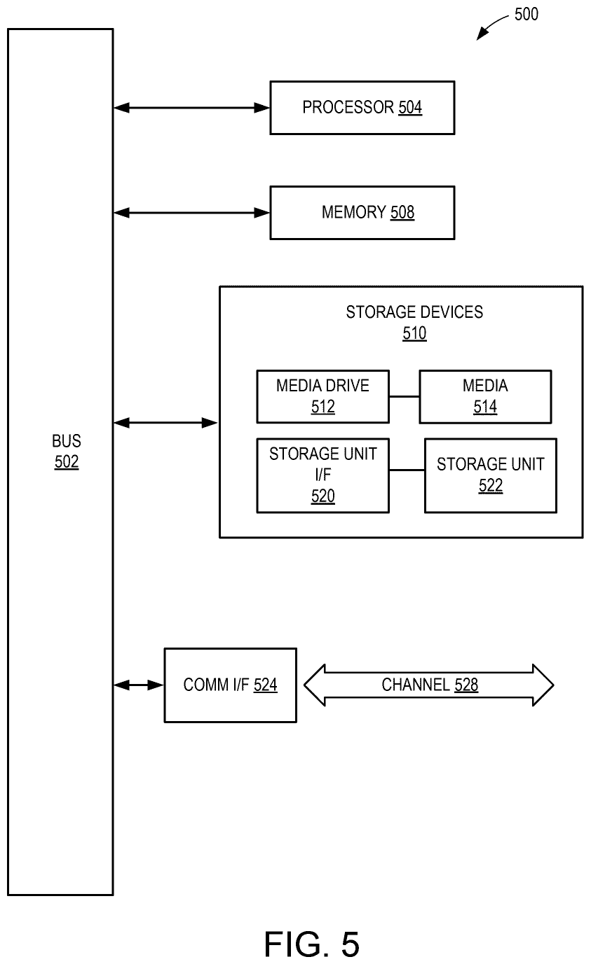

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components making up vehicles 102, proxy device 108, RSU 104, and other components of FIG. 1. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 may store instructions that, when executed by processor 504, cause computing component 500 to perform one or more of operations described in connection with FIG. 4. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or soft modem, a network interface (such as Ethernet, network interface card, IEEE 802.XX or another interface). Other examples include a communications port (such as for example, a USB port, IR port, RS232 port Bluetooth® interface, or other port), or another communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 522, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
identifying, by a roadway device, a vehicle traveling on a roadway;
authenticating, by the roadway device, a proxy device associated with the vehicle; and
transmitting sensor data to the vehicle based on the authentication of the proxy device, wherein the vehicle is operated to navigate the roadway based on the sensor data.

2. The method of claim 1, further comprising:
obtaining a geographic location of the proxy device;
obtaining a geographic location of the vehicle; and
authenticating the vehicle based on the geographic location of the proxy device matching the geographic location of the vehicle.

3. The method of claim 2, wherein authenticating the vehicle based on the geographic location of the proxy device matching the geographic location of the vehicle comprises:
determining a geographic area of the vehicle based on the geographic location of the vehicle; and
determining that the geographic location of the proxy device is within the geographic area.

4. The method of claim 3, further comprising rejecting communications between the vehicle and the roadway device in a case where the geographic location of the proxy device is outside the geographic area.

5. The method of claim 1, wherein the proxy device is contained in a cabin of the vehicle.

6. The method of claim 1, wherein authenticating the proxy device uses a public key infrastructure.

7. The method of claim 1, wherein the proxy device is one of a: mobile phone, wearable smart device, a tablet computer, or laptop computer.

8. The method of claim 1, wherein identifying the vehicle traveling on the roadway comprises:
identifying one or more vehicles affected by a condition based on the sensor data, wherein the one or more vehicles are identified from a plurality of vehicles traveling on the roadway; and
transmitting the sensor data to the only the identified vehicles based on authenticating one or more proxy devices associated with the identified vehicles, wherein the sensor data is not transmitted to the remaining vehicles of the plurality of vehicles.

9. A vehicle, comprising:
a communication circuit configured to exchange communications with a roadway device;
a memory storing instructions; and
one or more processors communicably coupled to the memory and configured to execute the instructions to:
identify that the vehicle is traveling on a roadway;
receive, by the roadway device, authentication for a proxy device associated with the vehicle that is located in the vehicle's cabin; and
receive sensor data based on the authentication of the proxy device, wherein the vehicle is operated to navigate the roadway based on the sensor data.

10. The vehicle of claim 9, wherein the one or more processors are further configured to:
obtain a geographic location of the proxy device;
obtain a geographic location of the vehicle; and
receive the authentication for the vehicle based on the geographic location of the proxy device matching the geographic location of the vehicle.

11. The vehicle of claim 10, wherein the one or more processors are further configured to:
determine a geographic area of the vehicle based on the geographic location of the vehicle; and
determine that the geographic location of the proxy device is within the geographic area.

12. The vehicle of claim 11, wherein the one or more processors are further configured to reject communications between the vehicle and the roadway device in a case where the geographic location of the proxy device is outside the geographic area.

13. The vehicle of claim 9, wherein authenticating the proxy device uses a public key infrastructure.

14. The vehicle of claim 9, wherein the proxy device is one of a: mobile phone, wearable smart device, a tablet computer, or laptop computer.

15. The vehicle of claim 9, wherein the one or more processors are further configured to:
identify one or more vehicles affected by a condition based on the sensor data, wherein the one or more vehicles are identified from a plurality of vehicles traveling on the roadway; and
transmit the sensor data to only the identified vehicles based on authentication of one or more proxy devices associated with the identified vehicles, wherein the sensor data is not transmitted to the remaining vehicles of the plurality of vehicles.

16. A non-transitory machine-readable storage medium encoded with instructions, which, when executed by a processor, causes the processor to:
identify, by a roadway device, a vehicle traveling on a roadway;
authenticate, by the roadway device, a proxy device associated with the vehicle; and
transmit sensor data to the vehicle based on the authentication of the proxy device, wherein the vehicle is operated to navigate the roadway based on the sensor data.

17. The non-transitory machine-readable storage medium of claim 16, wherein the processor is further configured to:
obtain a geographic location of the proxy device;
obtain a geographic location of the vehicle; and
authenticate the vehicle based on the geographic location of the proxy device matching the geographic location of the vehicle using a public key infrastructure.

18. The non-transitory machine-readable storage medium of claim 17, wherein the processor is further configured to:
determine a geographic area of the vehicle based on the geographic location of the vehicle; and
determine that the geographic location of the proxy device is within the geographic area.

19. The non-transitory machine-readable storage medium of claim 18, wherein the processor is further configured to reject communications between the vehicle and the roadway device in a case where the geographic location of the proxy device is outside the geographic area.

20. The non-transitory machine-readable storage medium of claim 16, wherein the processor is further configured to:
identify one or more vehicles affected by a condition based on the sensor data, wherein the one or more vehicles are identified from a plurality of vehicles traveling on the roadway; and transmit the sensor data to the only the identified vehicles based on authenticating one or more proxy devices associated with the identified vehicles, wherein the sensor data is not transmitted to the remaining vehicles of the plurality of vehicles.
